(19) United States
(12) Patent Application Publication
(10) Pub. No.: US 2012/0256339 A1
(43) Pub. Date: Oct. 11, 2012

(54) FLAME RETARDANT COMPOSITE MATERIALS

(76) Inventor: Pieter Wouter Du Toit, Southern Paarl (ZA)

(21) Appl. No.: 13/441,248

(22) Filed: Apr. 6, 2012

Related U.S. Application Data
(60) Provisional application No. 61/472,937, filed on Apr. 7, 2011.

(51) Int. Cl. B29B 9/06

(52) U.S. Cl. 264/118

(57) ABSTRACT

Composite materials of the type with fibres embedded in a matrix, with flame/fire retardant (FR) capabilities are prepared by applying an FR substance to the surfaces of fibres, combining the fibres with molten thermoplastic material so that the fibres are embedded in the thermoplastic material, and manufacturing a product from the combined thermoplastic material and embedded fibres.

### FIELD OF THE INVENTION

This invention relates to the preparation of composite materials, of the type with fibres embedded in a matrix, with flame retardant (also referred to as “fire retardant” in the art, and referred to as “FR” herein after) capabilities, and to the manufacture of products from such materials.

### BACKGROUND TO THE INVENTION

In many instances, products made of potentially flammable materials, such as composite materials with thermoplastic matrices, need to be treated to have certain FR capabilities. In order to meet these requirements, FR additives are typically combined with the thermoplastic materials in a process known as “compounding”, which typically involves melting, mixing and pelletising the materials, to form compounded, FR pellets. The pellets can then be molten and combined with fibres into various polymer compositions and are used to manufacture products.

### SUMMARY OF THE INVENTION

According to the present invention there is provided a method of preparing a composite material, said method comprising:

applying an FR substance to the surfaces of fibres;

combining said fibres with molten thermoplastic material, so that the fibres are embedded in the thermoplastic material; and

manufacturing a product from said combination of thermoplastic material and embedded fibres.

The method may include a step of melting the thermoplastic material prior to combining it with the fibres, which have the FR substances on them.

The step of combining the molten thermoplastic material and the fibres may comprise feeding the fibres into apparatus including a screw rotating inside a barrel, such as a compounder or extruder (known in the art as the DLFT process or its variations).

Alternatively, the step of combining the molten thermoplastic material and the fibres may comprise the process known in the art as “pulrusion” to produce long glass fibre hardened pellets of about 7 mm to 11 mm, or longer, in length.

Alternatively, the step of combining the molten thermoplastic material and the fibres may comprise cutting the fibres before being combined with the molten thermoplastic material and combining the short (cut) fibres coated with the FR substance, with the thermoplastic material, e.g. with various polymer matrices. The fibres may be cut to lengths of about 3 to 6 mm, before being combined with the molten thermoplastic material.

The thermoplastic materials may already include other additives (in addition to FR substances and/or fibres), before being combined with the fibres.

The step of applying the FR substance to the fibres may occur after or before or in combination with other substances that have been applied to the fibre surfaces, e.g. substances known as “sizing”, which are intended to improve bonding between the fibres and the thermoplastic materials and to add various mechanical properties to the fibres.

### EXAMPLE

For a better understanding of the present invention and to describe how it may be carried into effect, the invention will now be described by way of non-limiting example.

Glass fibres are manufactured in the known manner and are coated with a “sizing” for use in combination with a particular thermoplastic compound in a composite material, e.g. glass fibres are manufactured and are coated with a sizing that is intended to enhance bonding between the fibre surfaces and polypropylene (PP) and to enhance some of the composite's mechanical properties or the properties of the glass fibre itself. The sized glass fibres are then also coated with a FR substance, although the FR substance could, in other embodiments of the invention, be combined with the sizing or could potentially be applied before the sizing.

The glass fibres are processed in known manners for use in the manufacture of composite products and in a preferred embodiment, the glass fibres are wound in rovings to keep the fibres as long as possible for best mechanical properties in the products.

The thermoplastic material (PP in the example) is fed into a screw compounder or extruder, preferably a continuous running, twin screw compounder and is molten by the action of the compounding screws. The glass fibre rovings are also fed to the compounder, although this is preferably downstream from the PP feed and preferably also downstream of the melting of the PP. Inside the compounder, the fibres are reduced in length and are very evenly distributed in the PP, to form a homogeneous mixture, which is used to manufacture products. The products can be manufactured by injection moulding the mixture of molten thermoplastic material and embedded fibres and if suitable moulding techniques are used, such as large diameter runners and ports and suitable mould design, the fibres are evenly distributed in the moulded product and impart FR properties to the whole product.

In embodiments using pultrusion processes, the molten thermoplastic material and the fibre rovings are combined in a die where the glass fibres are wetted with the molten thermoplastic material, to produce pellets. The pellets can later be used by melting them again and making products by injection or compression moulding.

1. A method of preparing a composite material, said method comprising:
applying the flame retardant (FR) substance to the surfaces of fibres;
combining said fibres with molten thermoplastic material, so that the fibres are embedded in the thermoplastic material; and
manufacturing a product from said combination of thermoplastic material and embedded fibres.

2. A method as claimed in claim 1, which includes a step of melting the thermoplastic material prior to combining it with the fibres, which have the FR substances on them.

3. A method as claimed in claim 1, wherein the step of combining the molten thermoplastic material and the fibres comprises feeding the fibres into apparatus including a screw rotating inside a barrel.

4. A method as claimed in claim 1, wherein the step of combining the molten thermoplastic material and the fibres comprises pulrusion, to produce long glass fibre hardened pellets with lengths of at least 7 mm.

5. A method as claimed in claim 4, wherein said pellets have lengths of between 7 mm and 11 mm.

6. A method as claimed in claim 1, wherein the step of combining the molten thermoplastic material and the fibres comprises cutting the fibres before being combined with the molten thermoplastic material and combining the cut fibres coated with the thermoplastic material.

7. A method as claimed in claim 6, wherein the fibres are cut to lengths of 3 mm to 6 mm, before being combined with the thermoplastic material.

8. A method as claimed in claim 1, wherein said thermoplastic materials already include other additives, before being combined with the fibres.

9. A method as claimed in claim 1, wherein the step of applying the FR substance to the fibres occurs after other substances have been applied to the fibre surfaces.

10. A method as claimed in claim 1, wherein the step of applying the FR substance to the fibres occurs before other substances are applied to the fibre surfaces.

11. A method as claimed in claim 1, wherein the step of applying the FR substance to the fibres occurs in combination with other substances being applied to the fibre surfaces.

12. A method as claimed in claim 2, wherein the step of combining the molten thermoplastic material and the fibres comprises feeding the fibres into apparatus including a screw rotating inside a barrel.

13. A method as claimed in claim 2, wherein the step of combining the molten thermoplastic material and the fibres comprises pulrusion, to produce long glass fibre hardened pellets with lengths of at least 7 mm.

14. A method as claimed in claim 2, wherein the step of combining the molten thermoplastic material and the fibres comprises cutting the fibres before being combined with the molten thermoplastic material and combining the cut fibres coated with the thermoplastic material.

15. A method as claimed in claim 2, wherein said thermoplastic materials already include other additives, before being combined with the fibres.

16. A method as claimed in claim 2, wherein the step of applying the FR substance to the fibres occurs after other substances have been applied to the fibre surfaces.

17. A method as claimed in claim 2, wherein the step of applying the FR substance to the fibres occurs before other substances are applied to the fibre surfaces.

18. A method as claimed in claim 2, wherein the step of applying the FR substance to the fibres occurs in combination with other substances being applied to the fibre surfaces.

19. A method as claimed in claim 13, wherein said pellets have lengths of between 7 mm and 11 mm.

20. A method as claimed in claim 14, wherein the fibres are cut to lengths of 3 mm to 6 mm, before being combined with the thermoplastic material.
